(19) United States
(12) Patent Application Publication
(10) Pub. No.: US 2025/0158551 A1
(43) Pub. Date: May 15, 2025

(54) SYSTEMS AND METHODS FOR ENERGY RECOVERY ON DRILLING RIGS

(71) Applicant: Ariss Controls & Electric Inc., Leduc (CA)

(72) Inventor: Richard Ariss, Leduc (CA)

(21) Appl. No.: 18/944,580

(22) Filed: Nov. 12, 2024

Related U.S. Application Data
(60) Provisional application No. 63/548,088, filed on Nov. 10, 2023.

(51) Int. Cl. H02P 27/06; E21B 3/02; H02P 25/022

(52) U.S. Cl. CPC H02P 27/06; E21B 3/022; H02P 25/022

(57) ABSTRACT

A system and method are described for recovering energy from an electric motor in a drawworks winch used to raise and lower a top drive unit and drill pipe and associated equipment on a drilling rig at a well site. The electric motor generates electric power when the top drive unit and drill pipe and associated equipment is lowered that can be used to power other electrical equipment located at the well site.

### PRIORITY STATEMENT

This application claims priority from U.S. Patent Application Ser. No. 63/548,088, entitled “Systems and Methods for Energy Recovery on Drilling Rigs” filed on Nov. 10, 2023 in the name of Richard Ariss; which is hereby incorporated by reference, in entirety, for all purposes.

### TECHNICAL FIELD OF THE INVENTION

This invention relates, in general, to the field of recovering energy on drilling rigs, and in particular, recovering energy from drawworks motors used on drilling rigs.

### BACKGROUND OF THE INVENTION

It is known that oilfield drilling and service rigs can have various horsepower and capacities from DC Motors and DC Drives to AC motors and AC Drives. Drilling rigs can consist of one or more mud pumps, a top drive unit and a drawworks winch having an electric motor. These systems each require large supplies of continuous electrical power. This electrical power can be delivered by large diesel, bi-fuel (diesel and natural gas combined) or 100% Natural Gas generators. In some cases, the drilling rig can also be supplied with commercial AC utility power from an electrical power grid.

The electric motor of the drawworks winch can generate electric energy by virtue of the dynamic braking capabilities of the drawworks AC motor to decelerate and hold large loads associated with raising and lowering the top drive unit connected to drill pipe and associated drilling apparatus.

It is, therefore, desirable to provide systems and methods that can recover the energy produced by the electric motor of the drawworks winch.

### SUMMARY OF THE INVENTION

In some embodiments, systems and methods for recovering energy from a motor of a drawworks winch on a drilling rig can be provided.

In some embodiments, the dynamic braking capabilities of an electric motor of a drawworks winch when decelerating and holding large loads can be used to generate electrical energy that can be recovered to power other electrical equipment on the drilling rig. In some embodiments, operating efficiency of drilling rigs can be increased by up to 40%.

Broadly stated, in some embodiments, a system can be provided for recovering energy created during operation of a drawworks winch on a drilling rig located at a well site into electrical energy that is then supplied back to other electric equipment located at the well site, the drawworks winch operatively coupled to and operated by an electric motor, the drawworks winch operatively coupled to a top drive unit and drill pipe and associated equipment via a cable or gear drive, wherein the top drive unit and associated equipment is raised and lowered when the drawworks winch is operated by the electric motor, the system comprising: a inverter comprising a direct current (“DC”) input and an alternating current (“AC”) output, the AC output operatively coupled to the electric motors, the inverter configured to invert DC power supplied to the DC input into AC power that is outputted from the AC output to power the electric motor, the inverter further configured to rectify AC electric power generated by the electric motor into generated DC power that is outputted from the DC input when the top drive unit is being lowered thereby causing the motor to be in a negative torque operating condition; a DC power bus operatively coupled to the DC input of the inverter; and an active front end unit or rectifier comprising a DC output and an AC input, the DC output operatively coupled to the DC power bus, the active front end unit or rectifier configured to rectify a source of supplied AC electric power coupled to the AC input into DC power that is outputted onto the DC power bus, the active front end unit or rectifier configured to regulate and maintain a pre-set DC power bus voltage on the DC power bus, the active front end unit further configured to invert the generated DC power into generated AC power that is outputted from the AC input when the generated DC power supplied to the DC power bus by the inverter exceeds the pre-set DC power bus voltage.

Broadly stated, in some embodiments, a method can be provided for recovering energy created during operation of a drawworks winch on a drilling rig located at a well site into electrical energy that is then supplied back to other electric equipment located at the well site, the drawworks winch operatively coupled to and operated by an electric motor, the drawworks winch operatively coupled to a top drive unit and drill pipe and associated equipment via a cable or gear drive, wherein the top drive unit and associated equipment is raised and lowered when the drawworks winch is operated by the electric motor, the method comprising the steps of: operating a system operatively coupled to the electric motor, the system further comprising: a inverter comprising a direct current (“DC”) input and an alternating current (“AC”) output, the AC output operatively coupled to the electric motors, the inverter configured to invert DC power supplied to the DC input into AC power that is outputted from the AC output to power the electric motor, the inverter further configured to rectify AC electric power generated by the electric motor into generated DC power that is outputted from the DC input when the top drive unit is being lowered thereby causing the motor to be in a negative torque operating condition, a DC power bus operatively coupled to the DC input of the inverter, and an active front end unit or rectifier comprising a DC output and an AC input, the DC output operatively coupled to the DC power bus, the active front end unit or rectifier configured to rectify a source of supplied AC electric power coupled to the AC input into DC power that is outputted onto the DC power bus, the active front end unit or rectifier configured to regulate and maintain a pre-set DC power bus voltage on the DC power bus, the active front end unit further configured to invert the generated DC power into generated AC power that is outputted from the AC input when the generated DC power supplied to the DC power bus by the inverter exceeds the pre-set DC power bus voltage; supplying the source of supplied AC electric power to the system to power the electric motor to operate the drawworks winch; producing generated DC power with the electric motor when the electric motor is in a negative torque condition when the top drive unit is being lowered, wherein the generated DC power is outputted from the DC input of the inverter associated with the electric motor that is in the negative torque condition onto the DC power bus; and powering the other electrical equipment with the generated AC power when the generated DC power comprises a DC voltage that exceeds the pre-set DC power bus voltage.

Broadly stated, in some embodiments, the system can further comprise a battery operatively coupled to the DC power bus.

Broadly stated, in some embodiments, the system can further comprise a DC-to-DC voltage regulator operatively coupling the DC power bus to the battery.

Broadly stated, in some embodiments, the system can further comprise one or more of a brake resistor and the top drive unit operatively coupled to the DC power bus.

Broadly stated, in some embodiments, wherein the generated AC power can be operatively coupled to an AC power bus.

Broadly stated, in some embodiments, the other electrical equipment can be operatively coupled to the AC power bus.

Broadly stated, in some embodiments, wherein the other electrical equipment can comprise one or more of a motor control centre, a mud pump, and a natural gas-powered electrical generator.

Broadly stated, in some embodiments, the system can further comprise a rectifier operatively coupled to the AC power bus, the rectifier configured to provide rectified electrical power to the mud pump via a second inverter operatively coupled therebetween.

Broadly stated, in some embodiments, the AC power bus can be operatively coupled to a source of commercial AC power.

Broadly stated, in some embodiments, the electric motor can comprise one or the other of: an asynchronous or induction electric motor; and a synchronous or permanent magnet motor.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a block diagram depicting one embodiment of a system for recovering energy from energy from drawworks motors used on drilling rigs;

FIG. 2 is a X-Y chart depicting the energy recovered on a drilling rig with an 850 horsepower drawworks over a single up/down cycle;

FIG. 3 is a X-Y chart depicting the energy recovered on a drilling rig with an 850 horsepower drawworks over eight up/down cycles; and

FIG. 4 is a is a X-Y chart depicting the energy recovered on a drilling rig with an 850 horsepower drawworks over a 24 hour period.

### DETAILED DESCRIPTION OF THE INVENTION

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Systems and methods for recovering energy from drawworks motors used on drilling rigs is provided.

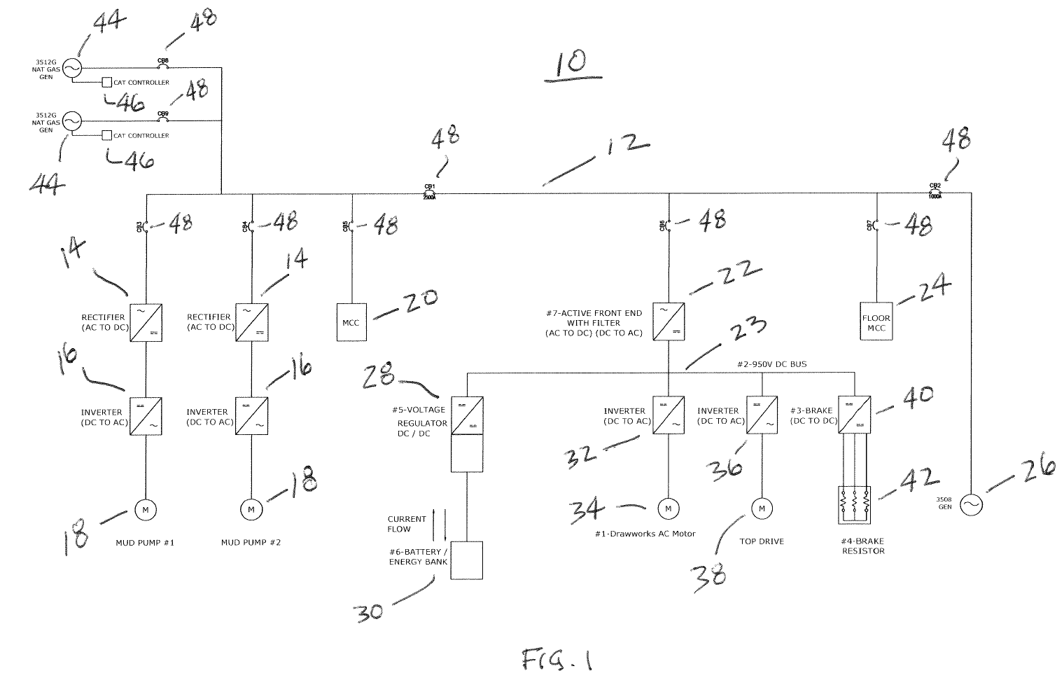

Referring to FIG. 1, one embodiment of energy recovery system 10 is shown. In some embodiments, system 10 can comprise of alternating current (“AC”) electrical power bus 12 (hereinafter referred to as “AC power bus 12”) configured to provide AC power to an AC input of active front end unit 22 that can rectify the AC power to direct current (“DC”) electrical power from a DC output of active front end unit 22 onto DC power bus 23. Active front end unit 32 can also be configured to invert DC power into generated AC power that can be outputted from the AC input of active front end unit 22 onto AC power bus 12.

In some embodiments, system 10 can comprise of a DC-to-DC voltage converter or voltage regulator 28 operatively coupled to DC power bus 23 wherein voltage regulator 28 can regulate current flow to and from battery bank 30 with DC power bus 23. In some embodiments, system 10 can comprise of AC-powered top drive unit 38 operatively coupled to DC power bus 23 via inverter 36, wherein inverter 36 can invert DC power from DC power bus 23 into AC power to power top drive unit 38. In some embodiments, system 10 can comprise of brake resistor 42 operatively coupled to DC power bus 23 via DC-to-DC converter 40. Brake resistor 42 can provide means for dissipating excess power on DC power bus 23 in the event that excess power on DC power bus 23 cannot be used to power drawworks motor 34 or top drive unit 38 or to charge battery 30.

In some embodiments, when the voltage on DC power bus 23 meets or exceeds a pre-set DC power bus voltage, active front end unit 22 can invert DC power on DC power bus 23 into generated AC power that can be outputted onto AC power bus 12 where the generated AC power can be used to power one or more pieces of AC-powered equipment operatively coupled to AC power bus 12. In some embodiments, the AC-powered equipment can comprise one or more of motor control centre 20, floor motor control centre 24, one or more mud pumps 18, one or more natural gas generators 44 and generator 26. In some embodiments, one or more of the AC-powered equipment can be operatively coupled to AC power bus 12 via an electrical power breaker 48 to provide means to isolate or disconnect any one piece of AC-powered equipment from AC power bus 12 in event of equipment failure or scheduled maintenance or repair. In some embodiments, each natural gas generator 44 can be controlled by a controller 46. In some embodiments, generator 26 can comprise a source of commercial AC power provided from an electrical power grid.

In some embodiments, during operation of system 10, the deceleration of drawworks motor 34 as it lowers top drive unit 38 during drill pipe tripping operations can generate large quantities of electrical energy. This energy is defined as regenerative energy (Access Energy). This energy can be transferred from drawworks motor 34 onto DC power bus 23 and can increase DC voltage thereon to 1000 VDC or more.

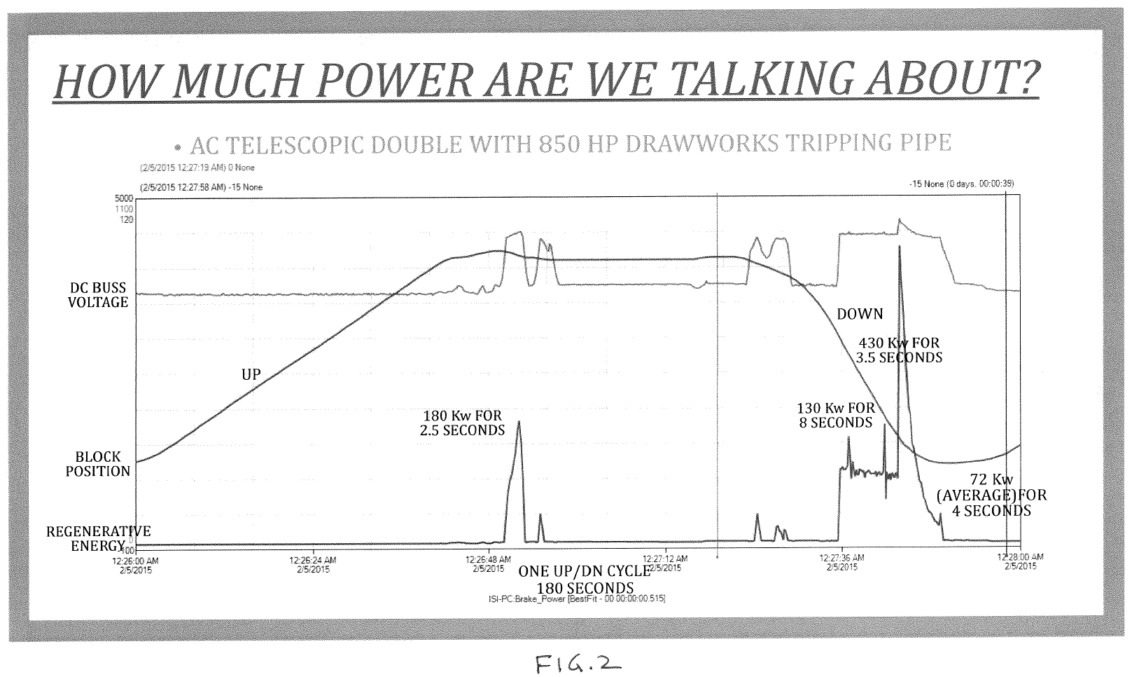

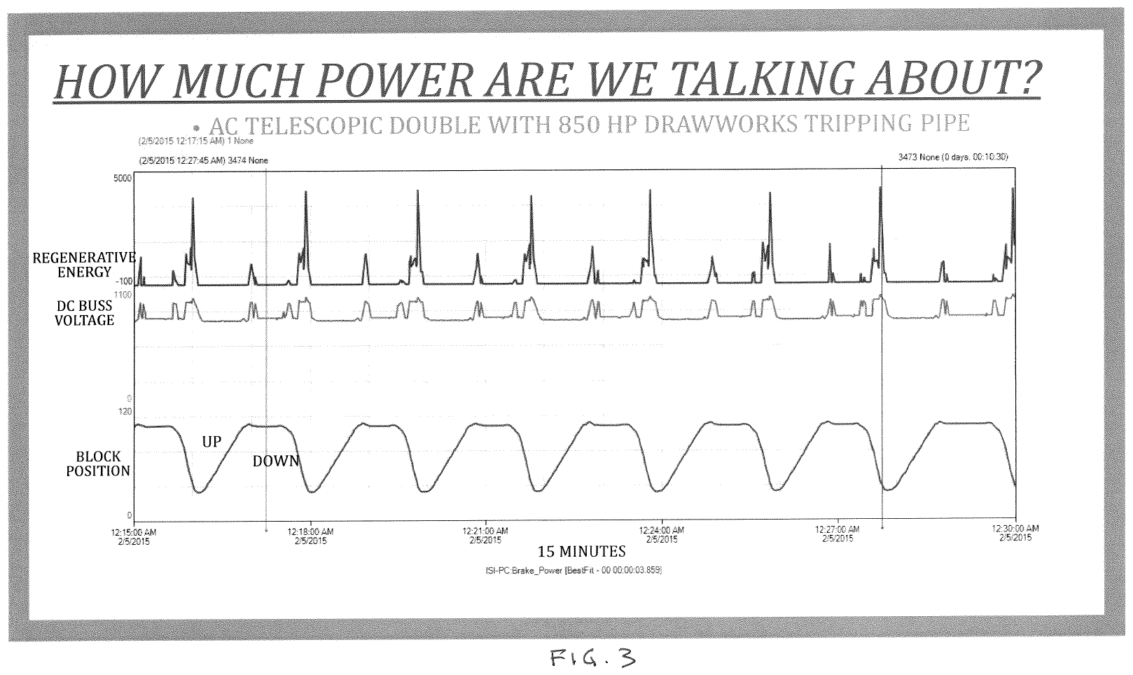

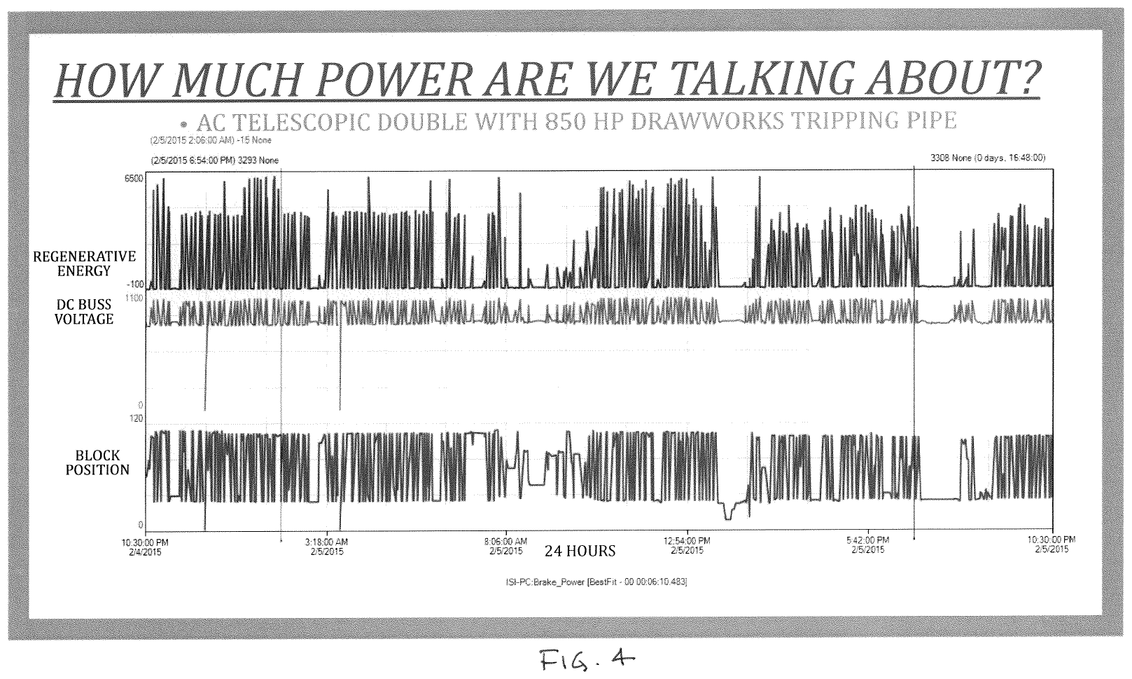

Referring to FIG. 2, an X-Y chart is shown of a single up/down cycle of an 850 horsepower (“HP”) drawworks motor tripping drill pipe. During this one cycle, 180 kilowatts of power can be generated for about 2.5 seconds when drawworks motor 34 is holding a double stack of drill pipe after raising it. Then, 130 kilowatts of power can be generated for about 8 seconds followed by 430 kilowatts of power being generated for about 3.5 seconds (72 kilowatts of power when averaged over about 4 seconds) when drawworks motor 34 is lowering the drill pipe. FIG. 3 illustrates the energy recovered from drawworks motor 34 over a 15 minute time period. FIG. 4 illustrates the energy recovered from drawworks motor 34 over a 24 hour time period.

In some embodiments, the energy recovered must be maintained at safe levels on DC power bus 23 and, therefore, this energy can be transferred to a large artificial load, such as brake resistor 42 via a brake chopper diode or a brake inverter IGBT denoted as reference character 40 on FIG. 1. This energy can be transferred inside the resistor system from electrical energy to heat and dissipated into the atmosphere. In some embodiments, this heat can be captured into buildings, or it can simply be released into the outside atmosphere.

In some embodiments, energy recovered from drawworks motor 34 and transmitted to DC power bus 23 can be stored on battery 30 via voltage regulator 28.

In some embodiments, system 10 can, during high energy consumption requirement times, transfer energy from battery 30 through voltage regulator 28 onto DC power bus 23 and then through active front end unit 22 onto AC power bus 12 to power AC-powered equipment operatively coupled thereto. This can result in less energy being required from 44 generators or from commercial AC power 26 being to power the electrical equipment of system 10.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

The order of execution or performance of the methods and process flows illustrated and described herein is not essential, unless otherwise specified. That is, elements of the methods and process flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for recovering energy created during operation of a drawworks winch on a drilling rig located at a well site into electrical energy that is then supplied back to other electric equipment located at the well site, the drawworks winch operatively coupled to and operated by an electric motor, the drawworks winch operatively coupled to a top drive unit and drill pipe and associated equipment via a cable or gear drive, wherein the top drive unit and the associated equipment is raised and lowered when the drawworks winch is operated by the electric motor, the system comprising:
a inverter comprising a direct current (“DC”) input and an alternating current (“AC”) output, the AC output operatively coupled to the electric motors, the inverter configured to invert DC power supplied to the DC input into AC power that is outputted from the AC output to power the electric motor, the inverter further configured to rectify AC electric power generated by the electric motor into generated DC power that is outputted from the DC input when the top drive unit is being lowered thereby causing the motor to be in a negative torque operating condition;
a DC power bus operatively coupled to the DC input of the inverter; and
an active front end unit or rectifier comprising a DC output and an AC input, the DC output operatively coupled to the DC power bus, the active front end unit or rectifier configured to rectify a source of supplied AC electric power coupled to the AC input into DC power that is outputted onto the DC power bus, the active front end unit or rectifier configured to regulate and maintain a pre-set DC power bus voltage on the DC power bus, the active front end unit further configured to invert the generated DC power into generated AC power that is outputted from the AC input when the generated DC power supplied to the DC power bus by the inverter exceeds the pre-set DC power bus voltage.

2. The system as set forth in claim 1, further comprising a battery operatively coupled to the DC power bus.

3. The system as set forth in claim 2, further comprising a DC-to-DC voltage regulator operatively coupling the DC power bus to the battery.

4. The system as set forth in claim 2, further comprising one or more of a brake resistor and the top drive unit operatively coupled to the DC power bus.

5. The system as set forth in claim 1, wherein the generated AC power is operatively coupled to an AC power bus.

6. The system as set forth in claim 5, wherein the other electrical equipment comprises AC-powered equipment operatively coupled to the AC power bus.

7. The system as set forth in claim 6, wherein the AC-powered electrical equipment comprises one or more of a motor control centre, a mud pump, and a natural gas-powered electrical generator.

8. The system as set forth in claim 7, further comprising a rectifier operatively coupled to the AC power bus, the rectifier configured to provide rectified electrical power to the mud pump via a second inverter operatively coupled therebetween.

9. The system as set forth in claim 5, wherein the AC power bus is operatively coupled to a source of commercial AC power.

10. The system as set forth in claim 1, wherein the electric motor comprises one or the other of:
an asynchronous or induction electric motor; and
a synchronous or permanent magnet motor.

11. A method for recovering energy created during operation of a drawworks winch on a drilling rig located at a well site into electrical energy that is then supplied back to other electric equipment located at the well site, the drawworks winch operatively coupled to and operated by an electric motor, the drawworks winch operatively coupled to a top drive unit and drill pipe and associated equipment via a cable or a gear drive, wherein the top drive unit and associated equipment is raised and lowered when the drawworks winch is operated by the electric motor, the method comprising the steps of:
operating a system operatively coupled to the electric motor, the system further comprising:
a inverter comprising a direct current (“DC”) input and an alternating current (“AC”) output, the AC output operatively coupled to the electric motors, the inverter configured to invert DC power supplied to the DC input into AC power that is outputted from the AC output to power the electric motor, the inverter further configured to rectify AC electric power generated by the electric motor into generated DC power that is outputted from the DC input when the top drive unit is being lowered thereby causing the motor to be in a negative torque operating condition,
a DC power bus operatively coupled to the DC input of the inverter, and
an active front end unit or rectifier comprising a DC output and an AC input, the DC output operatively coupled to the DC power bus, the active front end unit or rectifier configured to rectify a source of supplied AC electric power coupled to the AC input into DC power that is outputted onto the DC power bus, the active front end unit or rectifier configured to regulate and maintain a pre-set DC power bus voltage on the DC power bus, the active front end unit further configured to invert the generated DC power into generated AC power that is outputted from the AC input when the generated DC power supplied to the DC power bus by the inverter exceeds the pre-set DC power bus voltage;
supplying the source of supplied AC electric power to the system to power the electric motor to operate the drawworks winch;
producing generated DC power with the electric motor when the electric motor is in a negative torque condition when the top drive unit is being lowered, wherein the generated DC power is outputted from the DC input of the inverter associated with the electric motor that is in the negative torque condition onto the DC power bus; and
powering the other electrical equipment with the generated AC power when the generated DC power comprises a DC voltage that exceeds the pre-set DC power bus voltage.

12. The method as set forth in claim 11, wherein the system further comprises a battery operatively coupled to the DC power bus.

13. The method as set forth in claim 12, wherein the system further comprises a DC-to-DC voltage regulator operatively coupling the DC power bus to the battery.

14. The method as set forth in claim 12, wherein the system further comprises one or more of a brake resistor and the top drive unit operatively coupled to the DC power bus.

15. The method as set forth in claim 11, wherein the generated AC power is operatively coupled to an AC power bus.

16. The method as set forth in claim 15, the other electrical equipment is operatively coupled to the AC power bus.

17. The method as set forth in claim 16, wherein the other electrical equipment comprises one or more of a motor control centre, a mud pump, and a natural gas-powered electrical generator.

18. The method as set forth in claim 17, wherein the system further comprises a rectifier operatively coupled to the AC power bus, the rectifier configured to provide rectified electrical power to the mud pump via a second inverter operatively coupled therebetween.

19. The method as set forth in claim 15, wherein the AC power bus is operatively coupled to a source of commercial AC power.

20. The method as set forth in claim 11, wherein the electric motor comprises one or the other of:
an asynchronous or induction electric motor; and
a synchronous or permanent magnet motor.
